(19) United States
(12) Patent Application Publication
(10) Pub. No.: US 2005/0094564 A1
(43) Pub. Date: May 5, 2005

(54) ATM alarm and tracking system

(76) Inventor: Gene Hengsu Huang, Irvine, CA (US)

Correspondence Address: Curt Harrington, Suite 250, 6300 State University Drive, Long Beach, CA, 90815, US

(21) Appl. No.: 10/982,118

(22) Filed: Nov. 4, 2004

Related U.S. Application Data
(60) Provisional application No. 60/517,163, filed on Nov. 5, 2003.

(51) Int. Cl. G06F 17/60; H04L 1/00

(52) U.S. Cl. 370/236; 705/43

(57) ABSTRACT

An alarm system provides deterrence if an attempt is made to remove an ATM away from its intended location. The electronic circuit assembly is installed inside and outside of the ATM for siren and various means of notification to remote receivers if the trigger unit is triggered.

### FIELD OF THE INVENTION

The present invention relates to the application of alarm and tracking systems to be used in conjunction with Automated Teller Machines (ATM). More particularly, this invention relates to an electrical assembly that monitors activities in the telephone line and the AC (alternating current) power line connected to an ATM. If the telephone line and the AC power line are cut off from the ATM, a series of events will take place such as loud siren to ward off burglars, a Global Positioning System (GPS) and an external automatic response unit will send notification and information to pre-determined remote receivers.

### SUMMARY OF THE INVENTION

It is an object of the present invention to provide an alarm system that monitors both the telephone line and the AC power line. The monitor assembly, the siren, and the GPS system are installed inside the ATM, completely away from public access in a secured environment. An external automatic response unit is installed outside of the ATM in a separate private location which could be in the same premise as the ATM.

In the monitor assembly, an electronic circuit which acts as an electronic switch monitors whether or not the telephone line is connected to the ATM. While the telephone line is connected to the ATM, voltage is present at the Tip and Ring terminals of the telephone line. As long as this voltage is detected by the electronic circuit, the electronic switch remains open. If the Tip and Ring terminals are not connected to the ATM, this electronic switch will be closed.

A second electronic circuit which also acts as an electronic switch monitors whether or not the AC power line is connected to the ATM. If the AC power line is connected to the ATM, this electronic switch will remain open because it detects voltage on the AC power line. If the AC power line is not connected to the ATM, this electronic switch will be closed.

The alarm remains in the armed state and will not be triggered when either one of the following two conditions is true.

Condition one: when both the telephone line and the AC power line are connected to the ATM. (Both electronic switches are open).

Condition two: when either the telephone line or the AC power line is connected to the ATM. (One of the electronic switches is open).

The alarm will be triggered if both the telephone line and the AC power line are not connected to the ATM, a loud siren will be activated to deter burglary, a GPS system will continuously send current ATM location to remote pre-determined receivers for tracking purposes via wireless mean, and an external automatic response unit will call via telephone line and/or send e-mail, etc. through internet to remote pre-determined receivers for immediate attention.

Further objects and advantages of this invention will become apparent from consideration of the drawings and descriptions that follow.

### BRIEF DESCRIPTION OF THE DRAWINGS

Exemplary designs and embodiments of the invention will now be described in conjunction with the drawings in which:

FIG. 1 is showing a monitor block diagram which consists of an electronic switch 1 monitors the telephone line tip and ring terminals, electronic switch 2 monitors the AC power line, and a trigger unit which connects to the siren and the GPS system both installed inside the ATM, and the trigger unit is also connected to an external automatic response unit outside the ATM.

FIG. 2 is showing the alarm assembly and the GPS systems 6 which are installed inside the ATM chassis 1. The siren 3 and GPS system 6 are connected to the monitor unit 2. The monitor unit 2 is monitoring the activities of the telephone line and the AC power line. An external automatic response unit 3 is installed outside and away from the ATM and is connected through a wire 5 to the monitor unit 2.

FIG. 3 is showing the connection between the external automatic response unit and the monitor unit inside the ATM, and the telephone line or broadband connection.

### DETAILED DESCRIPTION OF THE INVENTION

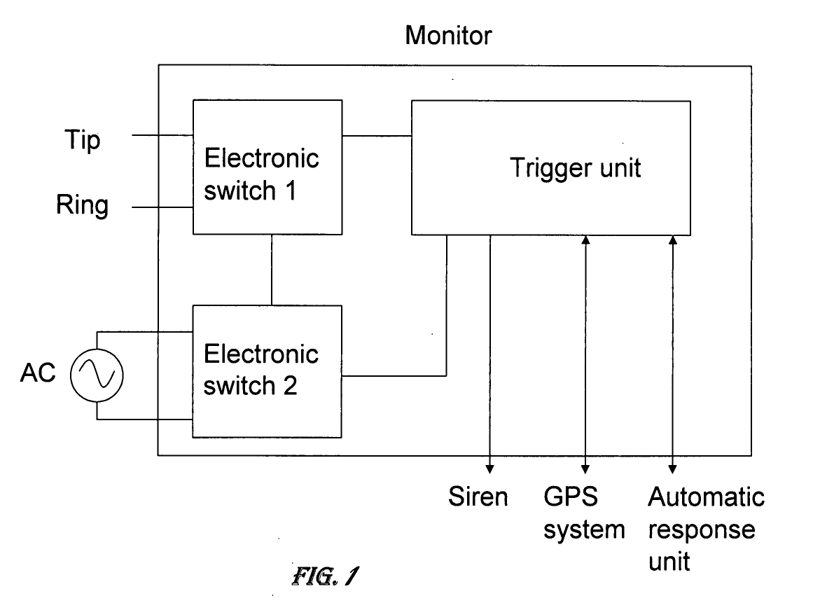

FIG. 1 is showing that electronic switch 1 is an open circuit if the telephone phone line is either on-hook, off-hook, or ringing. If the telephone line is not connected to the ATM for any reason, switch 1 will be closed. Similarly, electronic switch 2 is an open circuit if AC power line is connected to the ATM. It will be closed if the AC power line is not connected to the ATM. The trigger unit will be triggered if both electronic switch 1 and 2 are close circuit, and it will send a loud audible sound through the siren connected to the trigger unit. The trigger unit will also trigger the GPS system which will continuously send current ATM location to pre-determined remote receivers for tracking purposes via wireless mean such as cellphone network. The trigger unit will also trigger the external automatic response unit to call and/or send notification to pre-determined remote receivers for immediate attention via telephone line or broadband internet.

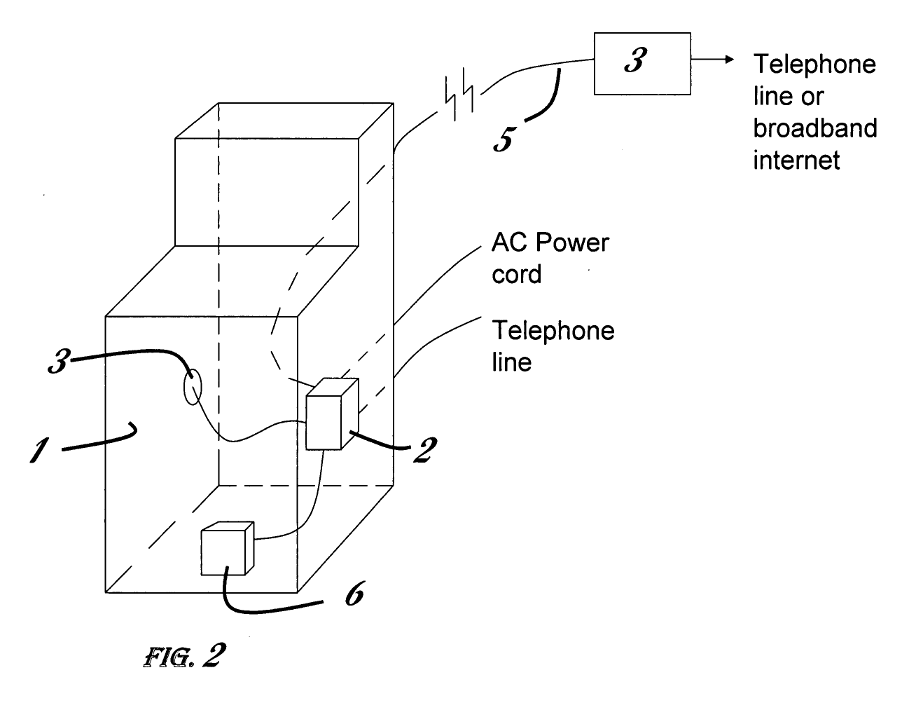

FIG. 2 is showing the general placement of this invention with reference to the ATM. The monitor 2, installed inside the ATM chassis 1, monitors if the telephone line and the AC power line are connected to the ATM. The siren 3, which is installed inside the ATM chassis 1, is connected to the monitor 2. The siren 3 will be activated when the trigger unit in the monitor is activated.

The GPS system 6 is connected to the monitor, and it will be activated when the trigger unit in the monitor is activated. This GPS system will continuously send current ATM location to pre-determined remote receivers for tracking purposes.

The external automatic response unit 3 will be activated as well when the trigger inside the monitor unit is activated. This external automatic response unit 3 will call and/or send notification to pre-determined remote receivers for immediate attention.

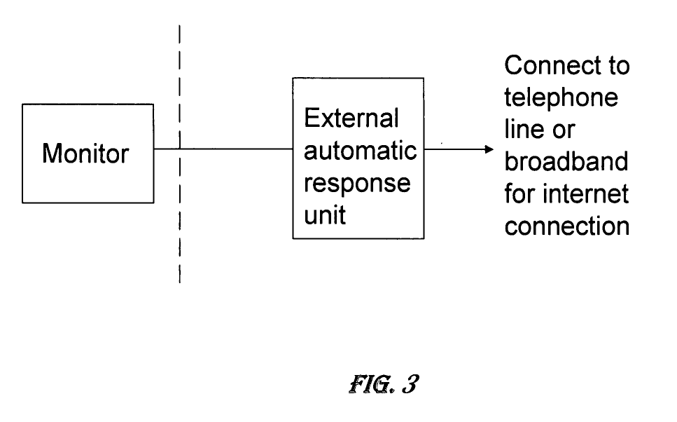

FIG. 3 is showing an external automatic response unit which is installed outside and away from the ATM in a separate secured private location. It is connected to telephone line and/or broadband connection. When the monitor detects that both the telephone line and the AC power line are not connected to ATM, the trigger in the monitor unit will send a signal to the external automatic response unit which will automatically call pre-determined phone numbers or send e-mails to pre-determined receivers for immediate attention.

While this invention is susceptible of designs in many different forms, this specification and the accompanying drawings disclose only some specific forms as examples of the invention. The invention is not intended to be limited to the designs so described. However, the scope of the invention is pointed out in the appended claims.

1. An ATM alarm system comprising: an electronic circuit which monitors if the telephone line is connected to the ATM. A second electronic circuit monitors if the AC power line is connected to the ATM. If both the telephone line and the AC power lines are not connected to the ATM, the trigger unit will be triggered and a series of events will take place.

2. When the trigger unit is triggered, a loud audible siren will sound.

3. When the trigger unit is triggered, an external automatic response unit will call pre-determined phone numbers and/or e-mail to pre-determined receivers for immediate attention.

4. When the trigger unit is triggered, the GPS system will continuously send ATM current location to pre-determined receivers for tracking purposes.
